(19) United States
(12) Patent Application Publication
(10) Pub. No.: US 2003/0074577 A1
(43) Pub. Date: Apr. 17, 2003

(54) Return-to-owner security lockout for a portable electronic device

(76) Inventors: Heather N. Bean, Fort Collins, CO (US); John M. Baron, Longmont, CO (US)

Correspondence Address: HEWLETT-PACKARD COMPANY, Intellectual Property Administration, P.O. Box 272400, Fort Collins, CO, 80527-2400, US

(21) Appl. No.: 09/982,345

(22) Filed: Oct. 17, 2001

(51) Int. Cl. H04L 9/32

(52) U.S. Cl. 713/200

(57) ABSTRACT

A security lockout method for an electronic device and a portable electronic device having security lockout facilitate returning a lost or stolen device to an owner. The method comprises displaying owner information on an interface of the device when a security lockout disables the device. The security lockout disables the device if a security lockout bypass input either is invalid when received or is expected but is not received. Owner information can be direct contact information for the owner or can be contact information for a lost and found service or other contact. The electronic device having return-to-owner security lockout comprises a controller, a user interface, a memory, and a computer program stored in the memory. The computer program preferably implements the method of the present invention.

### TECHNICAL FIELD

The invention relates to electronic devices. In particular, the invention relates to portable electronic devices, especially those having an integrated display interface.

### BACKGROUND OF THE INVENTION

Portable electronic devices including, but not limited to, notebook and laptop computers, hand-held computers and personal digital assistants (PDAs), digital still cameras, video cameras, and cellular telephones are popular, widely available, and in widespread use. Some portable devices, such as digital cameras and PDAs, would be of little or no value if it where not for their portability. For other portable devices, marketability and popularity are due in large part to the freedom to transport and use these devices just about anywhere.

At present, portable electronic devices account for a sizable portion of the consumer electronic market. Expected improvements in battery technology and in the power consumption of electronics used in portable devices concomitant with a continued decrease in component size and unit cost portend a continued growth in the portable electronic device market for the foreseeable future.

Although prices for many portable electronic devices have historically decreased as a function of time from device introduction, portable electronic devices are often still relatively expensive. Retail prices for individual portable electronic devices typically range from several hundred to several thousand dollars. A digital camera retailing for around one thousand dollars, for example, still represents a significant investment for the average consumer.

Unfortunately, portability is both a blessing and a curse for portable electronic devices. Portability makes the device attractive and/or useful to the user or owner. On the other hand, portability makes keeping track of the device more difficult. In short, portable electronic device are prone to being lost or stolen. Given the not-so-insignificant cost of many portable electronic devices, security features for these devices are of great interest and potential value.

In general, security features used with portable electronic devices seek to render the devices less attractive to or even useless to all but an authorized user (e.g, an owner). In most cases the security feature simply attempts to keep an unauthorized user from using the device. If the device will not function for an unauthorized user, the device will have no value.

Conventional portable electronic device security features range from simple, externally applied devices, such as locks or alarms, to sophisticated built-in functions of the electronic device. Among the built-in features available on such devices, such as laptop computers, are password-based security lockout functions that disable the device unless a valid password is entered. Without the password, the device is rendered non-operational, thereby greatly decreasing its value to a would-be thief. The lockout feature also reduces the value of the device to an otherwise honest individual that happens to find a lost device.

Unfortunately, while conventional security features may successfully deny use of the device to unauthorized users, these features generally fail to address the related problem of reuniting the lost or stolen device and its rightful owner. Since many portable electronic devices are relatively expensive, most owners greatly appreciate the return of a lost or stolen device. However, simply denying use of the device does little to facilitate its return.

Accordingly, it would be nice to have a security lockout feature for portable electronic devices that both disabled the device to deny use to an unauthorized user and provided a way to return the device to its rightful owner. Such a security lockout feature would fulfill a long-felt need in the area of portable electronic devices.

### SUMMARY OF THE INVENTION

The present invention is a method of return-to-owner security lockout for an electronic device and a portable electronic device having return-to-owner security lockout. The return-to-owner security lockout according to the present invention comprises displaying owner information when a security lockout disables the electronic device. The present invention can prevent all but a rightful owner from using the device. Moreover, the present invention facilitates the return of the device, if lost or stolen, to its rightful owner by displaying owner information when lockout is activated. The return-to-owner security lockout of the present application utilizes a user interface of the electronic device to display the owner information.

According to the present invention, the return-to-owner security lockout is preferably initiated during a start-up process each time the device is turned ‘ON’. The security lockout of the present invention may be initiated at other times during device operation either in addition to or other than during the start-up process. If a valid security bypass input is received after security lockout initiation, the security lockout is deactivated and the electronic device begins normal operation. When a valid security bypass input is not received, the security lockout is activated. While the security lockout is active, the device is disabled and the user interface of the device is used to display owner information. Owner information may be the name and an address and/or telephone number of the owner or a name and an address and/or telephone number of a ‘lost and found’ service or clearinghouse. Someone other than the rightful owner of the electronic device can use the displayed information to return the electronic device to the owner directly or alternatively, to return the device to the lost and found service that, in turn, forwards the electronic device to the owner.

In one aspect of the invention, a method of return-to-owner security lockout for a portable electronic device is provided. The method comprises receiving a security lockout bypass as an input to the device from a user and comparing the received lockout bypass to a lockout bypass template or expected input to determine whether or not the lockout bypass is valid. If the bypass input does not correspond to the bypass template, the bypass input is considered to be invalid. Further, if no bypass input is received, security lockout is activated. The security lockout disables the device and displays owner information. Where the owner information displayed is contact information for a lost and found service, the method further comprises providing a lost and found service. The service receives the electronic device, uses owner identification information to determine an address or a telephone number of the owner, and contacts the owner. Either the electronic device is sent to the owner using the address or the owner can pick up the device from the service.

In another aspect of the invention, an electronic device having a return-to-owner security lockout is provided. The electronic device comprises a controller, a memory, a user interface, and a computer program stored in memory. The controller executes the computer program. The computer program, when executed, implements the return-to-owner security lockout according to the present invention. The device displays owner information on the user interface when a security lockout disables the device. Preferably, the security lockout embodied in the computer program implements the method of return-to-owner security lockout of the present invention.

In particular, the computer program contains instructions that, when executed, activate lockout and disable normal operation of the device unless a valid lockout bypass input is received by the device. The specific forms of the lockout bypass input depends on a type of security lockout employed and include, but are not limited to, a password entered via the user interface or a unique key inserted into the device. When the device is disabled, the computer program displays the owner information. The owner information may contain one or more of the owner's name, the owner's address and/or telephone number, and a name, address and/or telephone number of a lost and found service. When lockout is not active and the device is not otherwise disabled, the identification information can be edited so that change of ownership and other information updates can be readily accommodated. The computer program may be stored in memory as either firmware or software.

The return-to-owner security lockout of the present invention provides security for a portable electronic device by denying use to an unauthorized user. Furthermore, the present invention facilitates reuniting the device and owner by virtue of displaying owner information should the device be lost or stolen. Furthermore, according to the present invention, the owner information can be updated if ownership of the electronic device changes through a legitimate means. Certain embodiments of the present invention have other advantages in addition to and in lieu of the advantages described hereinabove. These and other features and advantages of the invention are detailed below with reference to the following drawings.

### BRIEF DESCRIPTION OF THE DRAWINGS

The various features and advantages of the present invention may be more readily understood with reference to the following detailed description taken in conjunction with the accompanying drawings, where like reference numerals designate like structural elements, and in which:

FIG. 1 illustrates a flow chart of a method of return-to-owner security lockout for an electronic device of the present invention.

FIG. 2 illustrates a block diagram of an electronic device having a return-to-owner security lockout according to the present invention.

FIG. 3 illustrates a block diagram of electronic device having a return-to-owner security lockout according to the present invention in a preferred embodiment as a digital camera.

FIG. 4 illustrates a block diagram of an imaging subsystem of the digital camera in FIG. 3.

FIG. 5 illustrates a block diagram of a user interface of the digital camera of FIG. 3.

FIG. 6A illustrates an example of a display of owner information comprising an owner name and an owner address.

FIG. 6B illustrates an example of a display of owner information comprising contact information for a lost and found service.

### MODES FOR CARRYING OUT THE INVENTION

Associated with securing a portable electronic device by denying use to unauthorized users is the concomitant ‘return-to-owner’ problem. The return-to-owner problem includes how to identify the owner of a lost or stolen portable electronic device and how to provide for the return of the device to that owner. To reunite a lost or stolen portable electronic device and its rightful owner, a minimum requirement is to be able to identify the owner. A secondary requirement is to have a provision or means for contacting or locating the owner. For example, if a Good Samaritan finds a lost portable device, the Good Samaritan cannot hope to return the device to its owner if the owner's identity and contact information are unknown. Similarly, if a stolen device is recovered by a law enforcement agency, the law enforcement agency will generally consider owner identification an essential part of any effort to reunite the device and the owner.

Conventional approaches to solving the return-to-owner problem include such things as nametags, labels affixed to the device, and various forms of engraved indicia. Nametags and labels are common, well known, cheap, and simple to employ. However, nametags can be removed easily. The removal may be either intentional or inadvertent but the result is the same, i.e., a device with an unidentifiable owner. Labels affixed to the device either through the use of adhesives or other means can also be removed. Even if removal is not easily accomplished, often nametags and labels can be rendered unreadable by environmental conditions to which the portable device is subjected during normal use. Engraving offers a more permanent means of owner identification. Unfortunately, the very permanence of engraving makes changing ownership inconvenient. For example, if the owner of a device wishes to sell the device, engraved indicia can pose a complication for updating the proper identification of the new owner. In addition to the problem of updating ownership identification, engraving often requires that the device housing be partially defaced, an act that may decrease the esthetic qualities and resale value of the device.

Thus, a portable electronic device having a security lockout feature, which both disables the device to deny use to an unauthorized user and simultaneously provides for an identification of the rightful owner, fulfills a long-felt need in the area of portable electronic devices. Advantageously, such a security lockout feature facilitates the return of the lost or stolen electronic device to its rightful owner and further, also provides for updating and changing the ownership identification and contact information if and when the ownership of the device legitimately changes.

The present invention is a method of return-to-owner security lockout for an electronic device and a portable electronic device having return-to-owner security lockout. According to the present invention, a portable electronic device is disabled if a valid lockout bypass input is not received. The security lockout of the present invention effectively prevents the use of the electronic device by other than an authorized user. Moreover, when the device is disabled, an interface on the electronic device is employed by the present invention to display owner information. The displayed owner information facilitates the return of a lost or stolen portable device to its rightful owner. Furthermore, the authorized user or the owner can update the owner information when the device is not disabled.

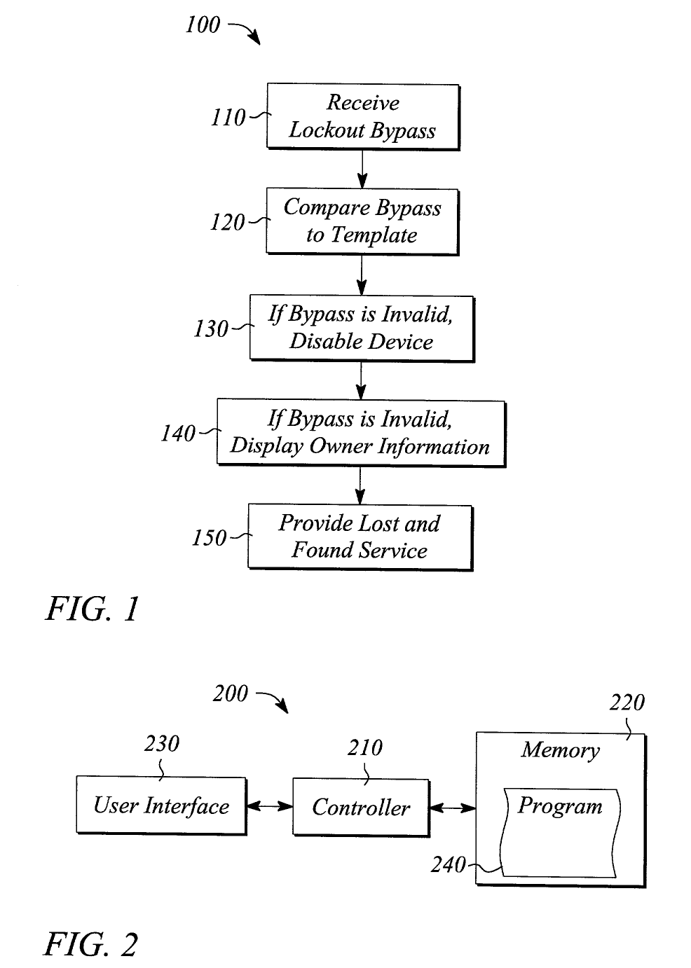

In one aspect of the present invention, a method 100 of return-to-owner security lockout for a portable electronic device is provided. A flow chart of the method 100 of the present invention is illustrated in FIG. 1. The method 100 comprises receiving 110 a lockout bypass input and comparing 120 the received lockout bypass to a lockout bypass template or expected input to determine whether or not the lockout bypass is valid.

The lockout bypass is an input to the electronic device that enables an authorized user to be unambiguously identified by the device. In other words, the lockout bypass is essentially unique to the authorized user. Any type of unique input can be used as the lockout bypass including, but not limited to, a password, a personal identification number (PIN), a coded radio frequency (RF) or infrared (IR) signal, a bar code scan, a retinal scan, a fingerprint scan, and a key (including a magnetic strip key card) that is inserted into the device. One skilled in the art is familiar with many other such means for unambiguously or uniquely identifying an authorized user to an electronic device, all of which are within the scope of the present invention.

For example, consider a lockout bypass comprising a password or equivalently a personal identification number (PIN). A password or PIN unique to the user is employed as a means of identifying the user to the device employing the method 100. As used in conjunction with the present invention, the password or PIN serves as an unambiguous means of identification in a manner that is entirely analogous to the use of a password in conjunction with various computer system accounts, bank accounts, and credit card accounts.

Continuing with the password or PIN lockout bypass example, the step of receiving 110 a lockout bypass input comprises issuing a request for a password. Typically, the device utilizing the method 100 issues the request. In some embodiments, the authorized user knows that a lockout bypass input is necessary to enable the device. Therefore, the step of issuing a request for the lockout bypass input is considered optional for the present invention. The step of receiving 110 further comprises entering or inputting the password. The password can be entered into the device in many ways. Typically, the user enters the password into the device using a user interface of the device.

According to the password lockout bypass example, the step of comparing 120 compares the entered password to a password template stored in memory of the device. In some cases, the password is encoded or encrypted prior to the step of comparing 120. In such cases, the encoded password is compared to a similarly encoded password template stored in memory. If, during the step of comparing 120, the entered password matches or otherwise corresponds to the stored password template, the lockout bypass input is considered to be valid. If the passwords do not match or correspond, the bypass input is considered to be invalid.

The password can be input using the user interface provided by the electronic device in a manner familiar to one skilled in the art. For example, if the device provides keys or buttons, pressing the keys in an appropriate sequence may be used to enter the password or PIN. Alternatively, a ‘verbal’ password can be used in devices with voice recognition. In this alternative, the password may be spoken by the user as a means of inputting the password.

In another example, the step of receiving 110 the lockout bypass input comprises inserting a key into the device. The key has a unique characteristic, such as an encoded magnetic strip on a card or a mechanical pattern of grooves, ridges, and/or holes, that is recognizable by the device. A key, such as that used for an automobile ignition system, is one example of such a key. In this example, the step of comparing 120 compares the inserted key to a key template. If a correct key is inserted into the device, the comparison 120 determines that the lockout bypass input is valid. If a key is not inserted or an incorrect key is inserted, the lockout bypass input is considered to be invalid. In this example of the step of receiving 110, the key may remain inserted during device operation or the key may be removed once the step of comparing 120 is completed.

In yet another example, a fingerprint or retinal scan is used as the lockout bypass input. The step of receiving 110 in this example comprises performing and digitizing a fingerprint or retinal scan. The step of comparing 120 comprises comparing the digitized fingerprint or retinal scan to a stored fingerprint or retinal scan template of the authorized user. If the step of comparing 120 produces a match between the digitized scan and the template, the lockout bypass input is considered to be valid. If a match is not produced, the lockout bypass input is not valid. The term ‘match’ as used herein includes an identical or 1:1 match or an unambiguous correspondence between the input and the template.

In yet another example, the user transmits a coded message or signal to the device using an RF or IR transmitter. The coded signal in this case is the lockout bypass input. In this example, the step of receiving 110 may comprise transmitting the signal. The step of receiving 110 further comprises receiving the transmitted signal. In the step of comparing 120, the received signal or a representation of the received signal is compared to a representation or template of the signal stored in memory. As in the other examples, if the comparison 120 produces a match therebetween, the lockout bypass input is considered to be valid. If a match is not produced, the lockout bypass input is not valid. The above-referenced examples of various bypass lockout inputs of the step of receiving 110 are provided by way of example and are not intended to limit the scope of the present invention.

In a preferred embodiment, a lockout bypass is received 110 and compared 120 during a start-up process of the device. The device performs the start-up process each time the device is turned ‘ON’. Preferably, at some point during start-up, the device halts the start-up process and waits for a lockout bypass input. The device can wait indefinitely until a lockout bypass is received 110. More preferably, if a lockout bypass is not received 110 within a predetermined period of time, the lockout bypass is considered invalid. In addition, the step of receiving 110 may be repeated one or more times when an invalid lockout bypass is received, or when no input is received, to account for input errors and input time delays on the part of the user.

Once a valid lockout bypass is received 110, the device need not receive 110 another lockout bypass input until a next start-up process. Thus in some embodiments, once a lockout bypass is received 110, the device must be turned ‘OFF’ and back ‘ON’ before the steps of receiving 110 and comparing 120 are repeated. In other alternative embodiments, the steps of receiving 110 and comparing 120 the lockout bypass input may be performed at times either in addition to or other than during the start-up process, and even be repeated periodically during device operation following completion of the startup process. For example, the steps of receiving 110 and comparing 120 the lockout bypass input may be repeated approximately every 20 to 30 minutes during device operation, or at other time intervals. The alternative embodiments enable the device employing method 100 to periodically ‘check’ to see if an authorized user is still using the device. In this way, an authorized user who loses the electronic device after the valid lockout bypass input is received still can realize the benefits of the present invention.

The method 100 further comprises disabling 130 the device if or when an invalid lockout bypass is received 110. Once the step of comparing 120 has determined the lockout bypass input to be invalid, normal operation of the device is disabled 130. However, if the step of comparing 120 determines that a valid lockout bypass is received 110, the device is enabled instead of being disabled and operates normally. When enabled during start-up, the device can continue the start-up process. Once start-up is completed, the device becomes operational. If the security bypass lockout is requested during operation, the device can continue normal operation upon receipt of the correct bypass lockout input.

With reference to the password example above, if an incorrect password is input by the user during the start-up process or at other requested times, the device is disabled 130. Preferably, the device begins a shutdown process when disabled 130. Thus, the device turns itself ‘OFF’ if an invalid password is entered by the user, thereby effectively denying use to a user who does not have the correct password.

The method further comprises displaying 140 owner information if an invalid lockout bypass is received 110. The owner information is displayed preferably using the user interface of the device. For example, the owner information can be displayed on an alphanumeric display of the device.

The owner identification may include a name of an owner and may optionally include owner contact information. For example, the name and address and/or telephone number of the owner can be displayed. Alternatively, the owner information displayed may be contact information for a lost and found service. In addition to owner information, a message indicating that security lockout is active can be displayed to let a user know why the device is not functioning. Preferably, the step of displaying 140 is performed following each time an invalid lockout bypass is received 110. In general, return-to-owner information includes, but is not limited to, one or more of a name for the owner, an address for the owner, a telephone number for the owner, return-to-owner instructions, a device serial number, a name for a lost and found service, an address for the lost and found service, a telephone number for the lost and found service, lost and found service return instructions, return to manufacturer instructions, and return to law enforcement office instructions.

If the displayed owner information includes an address and/or telephone number for the owner, the owner can be contacted directly and the device can be returned directly to the owner. For example, a Good Samaritan finding the device can use the address to mail the device back to the owner. Likewise, a law enforcement agency recovering the device can contact the owner directly using the displayed address/telephone information. Alternatively, the device can display 140 a message that postage is guaranteed by a lost and found service along with the lost and found service address or contact information. In addition, a monetary reward or other inducement to return the device may be offered by the owner or the lost and found service as a means to encourage the return of the device. A reward announcement may be displayed along with the owner information.

Depending on the device, the display 140 of owner information can be momentary or continuous. A momentary display preferably lasts long enough for the information being displayed to be read and understood. Typically, one to five minutes is a sufficient display duration for such a momentary display of owner information. When the device begins a shutdown process after being disabled 130, the owner information is displayed 140 momentarily only for two minutes, for example. The use of a momentary display 140 of the owner information is usually for the purpose of conserving device power. After the momentary display duration has expired, the display may turn ‘OFF’ along with the device. In some embodiments, if device power from a battery or other source is sufficient, the displayed information may be continuously displayed 140 until a valid lockout bypass is received 110 by the device.

Momentary display of owner information may also be coupled to or activated by a sensor including, but not limited to, a position, touch and/or motion sensor, such that the information is momentarily displayed whenever the device is perturbed (e.g., touched or moved). For example, the owner information may be displayed for approximately one to five minutes each time the sensor detects device movement. Displaying owner information whenever the device is perturbed has an advantage of providing the information without requiring that the device be turned ‘ON’ and also, providing some battery power conservation when the device is sitting motionless and undisturbed.

If lost and found service contact information is displayed 140, the method 100 further comprises providing 150 a lost and found service. The lost and found service can be a service organization that is either affiliated or unaffiliated with the device manufacturer, law enforcement, or an insurance company, for example. The service organization can receive payment for the service periodically from the consumer, as a part of an insurance premium or service agreement fee, for example, that the consumer has on the electronic device. Likewise, the lost and found service may be affiliated with the consumer's homeowners/rental insurance company, or the like, and the fee is paid each time the homeowners/rental insurance premium comes due. The owner provides a device description, model number, serial number, and owner contact information to the lost and found service organization, as appropriate, which is kept on file in case the electronic device is lost or stolen and subsequently returned to the service organization.

The owner information along with any other information that is displayed is loaded into memory of the electronic device using any one of several conventional interface methods. For example, a user interface of the device that provides various buttons and/or keys can be used to load the owner information into the device. Preferably, the device provides a data input/output (I/O) interface, such as a Universal Serial Bus (USB). Such an I/O interface allows the owner information to be uploaded from a personal computer or another external source. One skilled in the art is familiar with such interfaces and their use in transferring data such as would be used to create the displayed information.

The lost and found service receives the disabled 130 electronic device from a party that finds the device, uses owner identification information to determine an address of the owner, and sends the device to the owner using the determined address. Such a lost and found service can use a serial number of the device in lieu of or in addition to the owner information stored in memory of the device. As mentioned hereinabove, the device does not have to have any actual owner identification information stored in memory since that information can be accessed by the lost and found service using the device serial number. As with owner contact information, the lost and found service information may be displayed 140 continuously or momentarily.

In another aspect of the invention, an electronic device 200 having a return-to-owner security lockout is provided. FIG. 2 illustrates a block diagram of the electronic device 200. The electronic device 200 comprises a controller 210, a memory 220, a user interface 230, and a computer program 240 stored in memory 220. The controller 210 executes the computer program 240 and controls the operation of the user interface 240 and the memory 220. The computer program 240 when executed implements the return-to-owner security lockout of the present invention and displays owner information on a display of the user interface 230. Preferably, the return-to-owner security lockout embodied in the computer program 240 implements the method 100 of return-to-owner security lockout of the present invention.

In particular, the computer program 240 contains instructions that, when executed, activate lockout and disable operation of the device 200 unless a valid lockout bypass input is received by the device 200. As discussed above, the lockout bypass input depends on a type of security lockout employed and includes, but is not limited to, a password entered via the user interface 230 or a key inserted into the device 200. While the device 200 is disabled, the computer program 240 displays the owner information. The owner information may contain one or more of the owner's name, the owner's address and/or telephone number, a name and address/telephone number of a lost and found service, as described above. When lockout is not active and the device 200 is not otherwise disabled, the owner information can be edited so that change of ownership and other information updates can be readily accommodated. The computer program 240 may be stored in memory 220 as either firmware or software.

Solely to facilitate further discussion, the electronic device 200 having return-to-owner security lockout is described below with reference to digital cameras. However, this description of the electronic device 200 as a digital camera is one preferred application and in no way is intended to limit the scope of the present invention. One of ordinary skill in the art can readily extend the discussion hereinbelow regarding the digital camera to any electronic device.

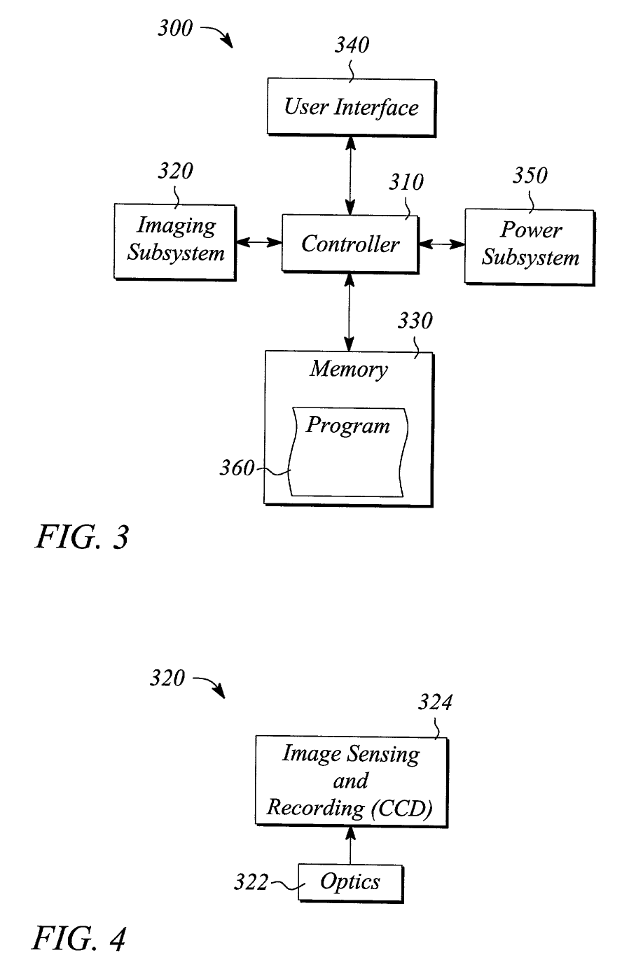

FIG. 3 illustrates a block diagram of the electronic device 300 of the present invention in the form of a digital camera 300 that employs return-to-owner security lockout. Recall that the digital camera 300 is simply a representative example of any electronic device 200 having a user interface 230. The digital camera 300 comprises a controller 310, an imaging subsystem 320, a memory subsystem 330, an interface subsystem 340, a power subsystem 350, and a control program 360 stored in the memory subsystem 330. The controller 310 executes the control program 360 and controls the operation of the subsystems 320, 330, 340, 350 of the digital camera 300. The power subsystem 350 provides operational power to the camera.

The controller 310 can be any sort of component or group of components capable of providing control and coordination of the subsystems 320, 330, 340, and 350. For example, the controller 310 can be a microprocessor or microcontroller. Alternatively, the controller 310 can be implemented as an application specific integrated circuit (ASIC) or even an assemblage of discrete components. The controller 310 is interfaced to the imaging subsystem 320, the memory subsystem 330, the interface subsystem 340, and the power subsystem 350. In some implementations, a portion of the memory subsystem 330 may be combined with the controller 310.

In a preferred embodiment, the controller 310 comprises a microprocessor and a microcontroller. The microcontroller has much lower power consumption than the microprocessor and is used to implement low power level tasks, such as monitoring button presses and implementing a real-time clock function of the digital camera 300. The microcontroller is primarily responsible for controller 310 functionality that occurs while the digital camera 300 is in ‘standby’ or ‘shutdown’ mode. The shutdown mode is a mode of the digital camera 300 when the camera 300 is being turned ‘OFF’. The microcontroller executes a simple computer program that, among other things, monitors button presses and maintains a real-time clock. Preferably the simple computer program is stored as firmware in read-only memory (ROM), the ROM preferably is built into the microcontroller.

On the other hand, the microprocessor implements the balance of the controller-related functionality. In particular, the microprocessor is responsible for all of the computationally intensive tasks of the controller 310, including but not limited to, image formatting, file management, and digital input/output formatting. In the preferred embodiment, the microprocessor executes the control program 360 that implements the method 100 of the present invention.

FIG. 4 illustrates a block diagram of the imaging subsystem 320 of the digital camera 300. The imaging subsystem comprises optics 322 and an image sensing and recording 324 portion. The sensing and recording 324 portion preferably comprises a charge coupled device (CCD) array. During operation of the camera 300, the optics 322 project an optical image onto an image plane of the image sensing and recording 324 portion of the imaging system 320. The optics 322 may provide either variable or fixed focusing, as well as optical zoom (i.e. variable optical magnification) functionality. The optical image, once focused, is captured and digitized by the image sensing and recording 324 portion of the imaging subsystem 330. Digitizing produces a digital image. The controller 310 controls the image capturing, the focusing and the zooming functions of the imaging subsystem 320. When the controller 310 initiates the action of capturing of an image, the imaging subsystem 320 digitizes and records the image. The digital image is then transferred to and stored in the memory subsystem 330.

The memory subsystem 330 comprises computer memory for storing digital images, as well as for storing the control program 360. Preferably, the memory subsystem 330 comprises a combination of non-volatile flash memory (e.g., electrically erasable, programmable, read only memory) and random access memory (RAM). The flash memory is used to store the control program 360, while the RAM is used to store digital images from the imaging subsystem 320 before the images are transferred to some type of non-volatile memory, such as a compact flash card, disk drive, etc. In particular, the flash memory stores a lock-out and bypass recognition portion (e.g., password template) of the control program 360 so that the security lockout cannot be circumvented by temporarily removing power from the digital camera 300. In addition, it is preferable that the control program 360 be stored in an area of the memory subsystem 330 that is checked during a firmware upgrade, so that the security lockout cannot be defeated by uploading a new control program 360 without first authenticating the user. The memory subsystem 330 may also store a directory of the images and/or a directory of stored computer programs therein, including the control program 360.

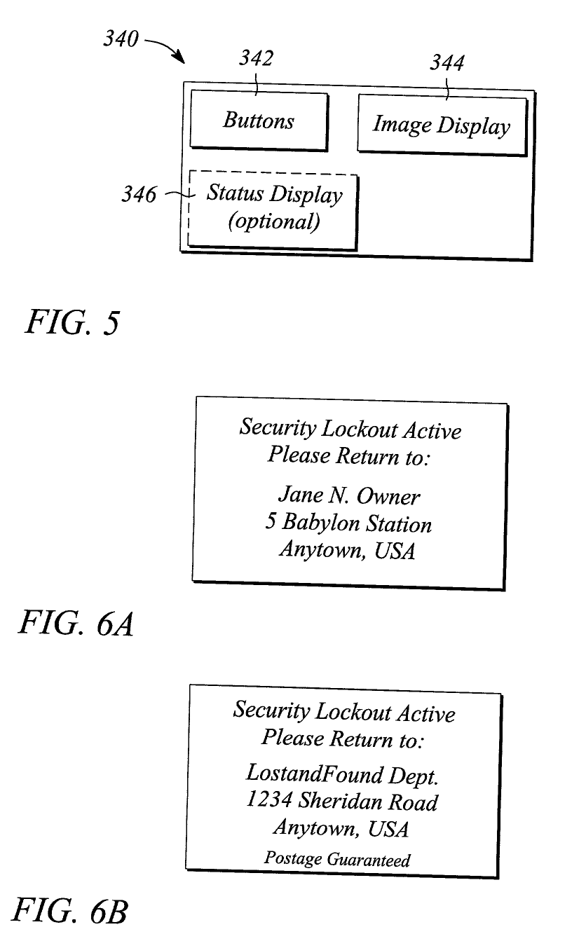

The interface subsystem 340 is illustrated as a block diagram in FIG. 5. The interface subsystem 340 comprises buttons 342 used by a user to interact with the control program 360 executed by the controller 310, thereby affecting user initiated control of the digital camera 300. For example, a button 342 may enable the user to initiate an image recording (i.e., ‘snap a picture’). Another button 342 may function as an ON/OFF switch, allowing the camera to be turned ON or OFF. Additionally, the buttons 342 can act as ‘arrow’ keys to allow a value to be incrementally controlled, or enable the user to navigate a menu and make selections. Furthermore, the buttons 342 can be used to enter a password as a lockout bypass. One skilled in the art is familiar with buttons that are used to provide user interface to a digital camera 300 or other electronic device 200.

The interface subsystem 340 further comprises an image display 344. The image display 344 enables the user to view a digital image stored in the memory subsystem 330. In addition, the image display 344 can provide a ‘real-time’ view of the image incident on the image sensing and recording 324 portion of the imaging system 320. In addition to viewing images, the image display 344 provides a means for displaying menus allowing the user to select various operational modes, and directories allowing the user to view and manipulate the contents of the memory subsystem 330. The image display 344 can also be used to display a request for password along with the owner information if a valid lockout bypass is not received. The image display 344 is typically a liquid crystal (LCD) display or similar display useful for displaying digital images.

The interface subsystem 340 further comprises an optional status display 346. The optional status display 346 provides ancillary information regarding the operational status of the digital camera 300. The status display 346 helps to reduce the ‘visual clutter’ of the image display 344. For example, the status display 346 might be used to display a fuel gauge that estimates power remaining in a battery. In addition, the status display 346 can be used to display to the user operational mode information, such as whether or not the digital camera 300 is in ‘trigger mode’, or is ‘ON’ or ‘OFF’. Typically, the status display 356 is an LCD display, although is a much less complex LCD display than that used for the image display 344.

The control program 360 implements a control algorithm that coordinates and controls the actions and operations of the subsystems 320, 330, 340, and 350. In particular, the control program 360 defines the operational meaning of the buttons 342 and generates and formats data displayed on the image display 344 and the optional status display 346; initiates image capturing and recording by the imaging subsystem 320; and implements data file storage and recovery by the memory subsystem 330. In short, the control program 360, in a first or conventional portion, implements a control algorithm that accomplishes all of the tasks necessary for conventional operation of the digital camera 300. The control program 360 is stored in the memory subsystem 330 and is generally referred to as the firmware of the digital camera 300. One skilled in the art is familiar with such digital camera 300 firmware. In particular, one skilled in the art can create digital camera 300 firmware that implements the conventional portion of the control program 360 without undue experimentation using conventional computer programming techniques.

In addition to the conventional portion providing for conventional operational functionality, the control program 360 comprises a return-to-owner security lockout portion that essentially implements the method 100 according to the invention. Advantageously, such a return-to-owner security lockout portion of the control program 360 may be implemented as a firmware upgrade to existing digital camera 300 firmware. Using the buttons 342 and the image display 344 of the user interface 340, the owner can input owner information upon receiving prompts from the computer program 360 to do so. Alternatively, the owner information can be uploaded from an external source such as a personal computer using an I/O port or interface provided by the digital camera 300 (not illustrated). This owner information is entered into, and is stored in and accessed from, the memory 330 only if a valid security lockout bypass has enabled the device.

FIGS. 6A and 6B illustrate an examples of the owner information displays. As illustrated in FIG. 6A, the owner information comprises an owner name and contact information, such as the owner's address and/or telephone number. FIG. 6B illustrates a display comprising lost and found service contact information. Both FIGS. 6A and 6B include an example of a message to a user indicating why the device is disabled. The type and quantity of information displayed during security lockout are not intended to limit the scope of the invention in any way. Any information that will directly or indirectly relate the electronic device to its rightful owner is within the scope of the present invention.

Thus, there have been described a novel method 100 of return-to-owner security lockout and an electronic device 200, 300 having return-to-owner security lockout. It should be understood that the above-described embodiments are merely illustrative of the some of the many specific embodiments that represent the principles of the present invention. Clearly, those skilled in the art can readily devise numerous other arrangements without departing from the scope of the present invention as defined by the following claims.

What is claimed is:

1. A method of return-to-owner security lockout for a portable electronic device comprising:
displaying return-to-owner information on an interface of the device when a security lockout disables the device.

2. The method of claim 1, wherein the step of displaying comprises:
comparing a security lockout bypass input to a security bypass template in the electronic device; and
disabling the electronic device when the security bypass input is invalid, wherein the security bypass input is invalid when it does not correspond to the security bypass template.

3. The method of claim 1, wherein the security lockout disables the device if no security lockout bypass input is received when expected or when the security lockout bypass input is received but does not correspond to a security bypass template stored in the electronic device.

4. The method of claim 2, wherein the security bypass input is compared during a start-up process of the electronic device, each time the device is switched to an ON state.

5. The method of claim 1, wherein the disabled electronic device remains in a start-up mode indefinitely until a valid security lockout bypass enables the device.

6. The method of claim 4, wherein the start-up process is terminated and the electronic device is disabled by switching to an OFF state if a valid security lockout bypass input is not received after a period of time, wherein the valid security bypass input corresponds to the security template.

7. The method of claim 1, further comprising:
enabling the electronic device when a valid security lockout bypass is received.

8. The method of claim 7, further comprising requesting a security lockout bypass periodically while the electronic device is enabled.

9. The method of claim 2, further comprising:
requesting a security lockout bypass, wherein the security lockout bypass is optionally requested each time the device is switched to an ON state and is requested periodically after a valid security lockout bypass enables the electronic device.

10. The method of claim 2, wherein the security lockout bypass comprises one or more of a password, a personal identification number (PIN), a fingerprint, a retinal scan, a coded radio frequency or infrared signal, a key, and a key card, the security lockout bypass being unique to an owner or an authorized user of the device.

11. The method of claim 2, further comprising repeating the step of comparing one or more times when the security bypass input is determined to be invalid.

12. The method of claim 11, wherein the electronic device is disabled and the return-to-owner information is displayed each time that the security bypass input is invalid.

13. The method of claim 1, wherein when the electronic device is disabled, a shutdown process switches the electronic device to an OFF state and the return-to-owner information is displayed one or both of during the shutdown process until the electronic device is OFF and until a security lockout bypass enables the electronic device.

14. The method of claim 13, the return-to-owner information is displayed one of continuously, periodically, and each time that a sensor in the electronic device detects a perturbation of the electronic device.

15. A method of return-to-owner security lockout for a portable electronic device comprising:
receiving a lockout bypass input from a user; and
comparing the bypass input to a bypass template for the electronic device to determine whether the bypass input is valid,
wherein either when an invalid bypass input is received or when the bypass input is expected but not received, the electronic device is disabled and return-to-owner information is displayed using an interface of the disabled device, and
wherein when a valid bypass input is received, the electronic device is enabled for use by the user.

16. The method of claim 15, wherein the bypass input is received and compared one or both of during a start-up process of the electronic device each time the device is switched to an ON state and periodically during device operation when the valid bypass input enabled the device.

17. The method of claim 15, further comprising repeating the steps of receiving and comparing one or more times when the bypass input is determined to be one of invalid and not received when expected.

18. The method of claim 15, wherein when the electronic device is disabled, a shutdown process switches the electronic device to an OFF state after which the return-to-owner information is displayed momentarily each time a sensor in the electronic device detects a perturbation of the electronic device.

19. The method of claim 15, wherein the return-to-owner information comprises one or more of a name for an owner, an address for the owner, a telephone number for the owner, return-to-owner instructions, a device serial number, a name for a lost and found service, an address for the lost and found service, a telephone number for the lost and found service, lost and found service return instructions, return to manufacturer instructions, return to law enforcement office instructions, and an informational message.

20. The method of claim 19, further comprising:
providing the lost and found service.

21. An electronic device having a return-to-owner security lockout comprising:
a memory;
a computer program stored in the memory;
a user interface; and
a controller that executes the computer program and controls the operation of the user interface and the memory, wherein the computer program implements instructions that, when executed by the controller, display return-to-owner information on the user interface when a security lockout disables the electronic device.

22. The electronic device of claim 21, wherein the electronic device is a digital camera that further comprises an imaging subsystem and a power subsystem, the controller further controlling the operation of the imaging subsystem and the power subsystem.

23. The electronic device of claim 22, wherein the power subsystem provides power to display the return-to-owner information when the camera is disabled.

24. The electronic device of claim 21, further comprising a sensor that detects a perturbation of the disabled electronic device, such that each perturbation causes the return-to-owner information to be displayed momentarily on the user interface.

25. The electronic device of claim 21, wherein the security lockout comprises instructions that receive a lockout bypass input from a user, compare the bypass input to a bypass template for the electronic device, disable the electronic device and display return-to-owner information on the user interface either when the bypass input fails to correspond to the bypass template or no bypass input is received when expected, and enable the electronic device when the bypass input corresponds to the bypass template.

26. The electronic device of claim 25, wherein the disabled electronic device completes a shutdown process and switches to an OFF state, the return-to-owner information being displayed one or both of during the shutdown process and while in the OFF state, and wherein the enabled electronic device one or both of completes a start-up process to become operational and continues operation.

27. The electronic device of claim 25, wherein the bypass template is stored in the memory.

28. The electronic device of claim 25, wherein the bypass input is received at the user interface.

29. The electronic device of claim 25, wherein the computer program and the bypass template are stored in a non-volatile flash memory portion of the memory, a firmware upgrade of the computer program and a modification to the bypass template each being allowed only if the device is enabled.
